(19) United States
(12) Patent Application Publication
(10) Pub. No.: US 2007/0165609 A1
(43) Pub. Date: Jul. 19, 2007

(54) Method of establising calls between a telephone terminal and an ip terminal

(76) Inventors: David Corvoysier, Rennes (FR); Katell Henry, Pleumeur Bodou (FR); Olivier Calliger, Paris (FR)

Correspondence Address: Thomas Langer;Cohen Pontani Lieberman & Pavane, Suite 1210, 551 fifth Avenue, New York, NY, 10176, US

(21) Appl. No.: 10/588,137

(22) PCT Filed: Jan. 26, 2005
(86) PCT No.: PCT/FR05/00162

§ 371 Date: Jul. 31, 2006

(51) Int. Cl. H04L 12/66

(52) U.S. Cl. 370/356

(57) ABSTRACT

A method of setting up multimedia calls from a telephone terminal (T1) to a terminal (T2) connected to an IP network. The terminal (T1) sends to a server (SMR) a call request (DA) containing an identifier (ID2) for the terminal (T2). The server (SMR) stores the identifier (ID2) in a table (TC) in association with a number (NT) and instigates the transmission by the terminal (T1) of an incoming call (AE) to a number (NS) connecting through to a call set-up gateway (PEA), the incoming call (AE) including a characteristic (CAR) for indicating a relationship between the numbers (NT) and (NS). The call set-up gateway (PEA) signals the characteristic (CAR) to the server (SMR), which determines the identifier (ID2) associated in the table (TC) with the corresponding number (NT) of the characteristic (CAR) to set up the call between the terminals (T1, T2).

The invention relates to a method of setting up multimedia calls from a first terminal, which is a telephone terminal, to a second terminal, which is connected to an IP network.

In one prior art method of this kind a call to the second terminal is set up from the telephone network via an IP/PSTN (Internet Protocol/Public Switched Telephone Network) gateway which converts telephone signaling into IP signaling, for example SIP, H.323 signaling. A voice channel is then set up as a point-to-point RTP stream between the second terminal and the gateway, and simultaneously a PSTN stream is set up between the calling first terminal and the gateway (RTP is a real-time transmission protocol used in packet-switched networks).

In that prior art method, the (called) second terminal has a called party telephone number enabling it to be selected from the (calling) first terminal and enabling the call to be set up.

Consequently, new telephone numbers must be dedicated to IP second terminals in order for it to be possible to call them from first terminals.

Those new telephone numbers for IP terminals are therefore additional to existing telephone numbers, which has the drawback that a very large number of them are required, as many as there are IP terminals.

Each IP terminal must register its dedicated telephone number, which is complicated and time-consuming.

New IP terminal telephone numbers must be integrated into existing numbering plans, which may result in plans becoming congested or it may even be impossible to integrate the new numbers, given limited numbering capacity (for example 10 digits in France at present), and the increasing number of telephone numbers required.

An object of the invention is to alleviate the drawbacks of the prior art by proposing a method and apparatus for setting up multimedia calls from a (telephone) first terminal to a second terminal connected to an IP network, and to do so without static assignment of a telephone number to the second terminal.

To this end, a first aspect of the invention is a method of setting up multimedia calls from a (telephone) first terminal to a second terminal connected to an IP network, the method being characterized in that in order to set up a call to the second terminal from the first terminal:
the first terminal sends to a connection server a call request containing a predetermined (called party) second identifier for the second terminal;
on receiving the call request, the connection server temporarily stores the (called party) second identifier in a correspondence table in association with a first number determined from the call request and instigates the sending by the first terminal of an incoming call to a particular second number which is a service number connecting to a call set-up gateway, the incoming call including a call characteristic to indicate a relationship between the first number and the (service) second number; and
the call set-up gateway signals at least the characteristic of the received incoming call to the connection server, which determines the (called party) second identifier associated in the correspondence table with the first number corresponding to the signaling of the characteristic of the incoming call in order to signal the incoming call to the second terminal corresponding to the (called party) second identifier determined in this way, in order to set up a multimedia communications channel between the second terminal and the call set-up gateway, which then connects the multimedia communications channel to the incoming call.

By means of the invention, the call to the second terminal is set up by means of a temporary correspondence established between the identifier of the second terminal, the (service) second number of the incoming call and the first number. It follows that the number of service numbers that the call set-up service requires in order to be able to forward incoming calls to the gateway can be limited to a predetermined number, and can even be equal to one, and is in any event much smaller than the number of second terminals. The invention thus dispenses with the static, systematic, and definitive assignment of telephone numbers to second terminals, which avoids having the same number of telephone numbers as there are second terminals and relieves the second terminals of having to register such numbers for the service.

According to other, non-limiting features of the invention:
the first number and the (service) second number are telephone numbers;
the (telephone) first terminal is a GPRS mobile telephone terminal;
the second terminal is connected beforehand to the connection server using a presence management protocol;
the (called party) second identifier is selected on the first terminal, selection of the (called party) second identifier on the first terminal being possible because the presence of the second terminal has been detected and signaled to the first terminal by the connection server;
the first number associated in the correspondence table with the second identifier is the telephone number of the first terminal contained in the call request and the characteristic of the incoming call for indicating a relationship between the first number and the (service) second number designates the incoming call coming from the telephone number of the first terminal and going to the (service) second number;
either the first number associated in the correspondence table with the second identifier is the telephone number of the first terminal contained in the call request and the characteristic of the incoming call for indicating a relationship between the first number and the (service) second number designates the incoming call coming from the telephone number of the first terminal and going to the (service) second number;
or the first number associated in the correspondence table with the second identifier is the (service) second number and the characteristic of the incoming call for indicating a relationship between the first number and the (service) second number designates the (service) second number;
the telephone number of the first terminal is contained neither in the call request nor in the incoming call;
the connection server determines the (service) second number from a pre-stored list of service numbers available for the call request and is communicated to the first terminal in an acknowledgement sent by the connection server after the (called party) second identifier is stored in the correspondence table;
the incoming call contains other characteristics of the communications channel to be set up which are also signaled with the incoming call to the connection server and to the second terminal;
a first identifier of the first terminal is present in the call request and is stored by the connection server in association with the (called party) second identifier and the first number;
the identifier is different from a telephone number of the corresponding terminal.

A second aspect of the invention is apparatus for implementing the above method of setting up multimedia calls from a (telephone) first terminal to a second terminal connected to an IP network, the apparatus being characterized in that it comprises:
a gateway for setting up calls between the first and second terminals;
a connection server including means for receiving a call request from the first terminal and means for commanding the first terminal to send an incoming call to a particular second number which is a service number connecting through to the call set-up gateway, the incoming call including a call characteristic for indicating a relationship between a first number and the (service) second number;
a correspondence table for storing the (called party) second identifier for the second terminal contained in the call request in association with the first number determined from the call request;
first means in the call set-up gateway for signaling at least the characteristic of the incoming call to the connection server;
means in the connection server for determining the (called party) second identifier associated in the correspondence table with the first number corresponding to the signaling of the characteristic of the incoming call and second means for signaling the incoming call to the second terminal corresponding to the (called party) second identifier determined in this way;
means for instigating the setting up of a multimedia communications channel between the second terminal and the call set-up gateway; and
means for connecting the multimedia communications channel to the incoming call via the call set-up gateway.

The invention can be better understood on reading the following description, which is given by way of non-limiting example only and with reference to the appended drawings, in which:

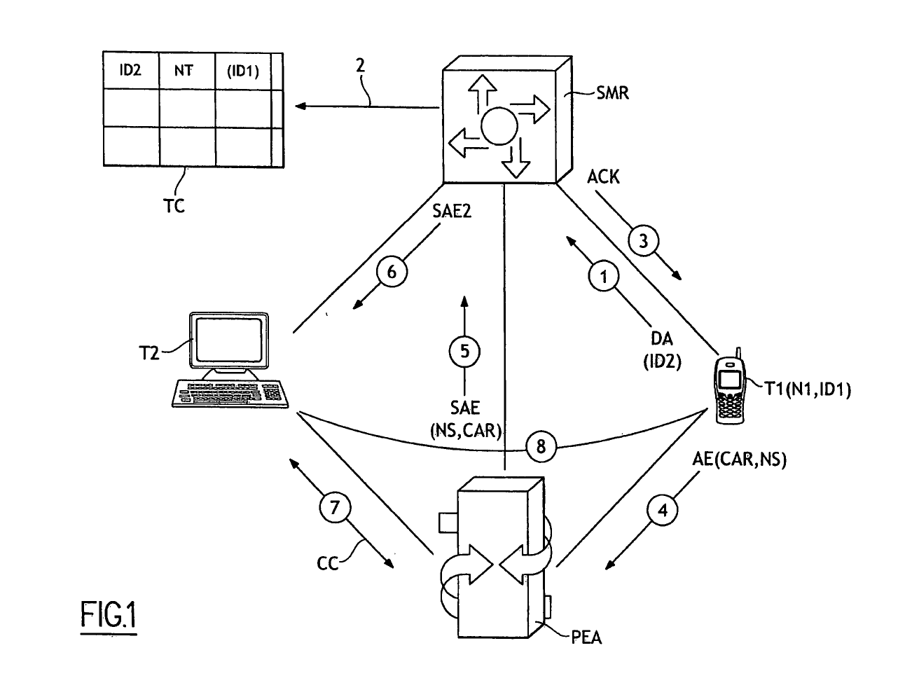

FIG. 1 is a diagram of apparatus implementing the call set-up method of the invention;

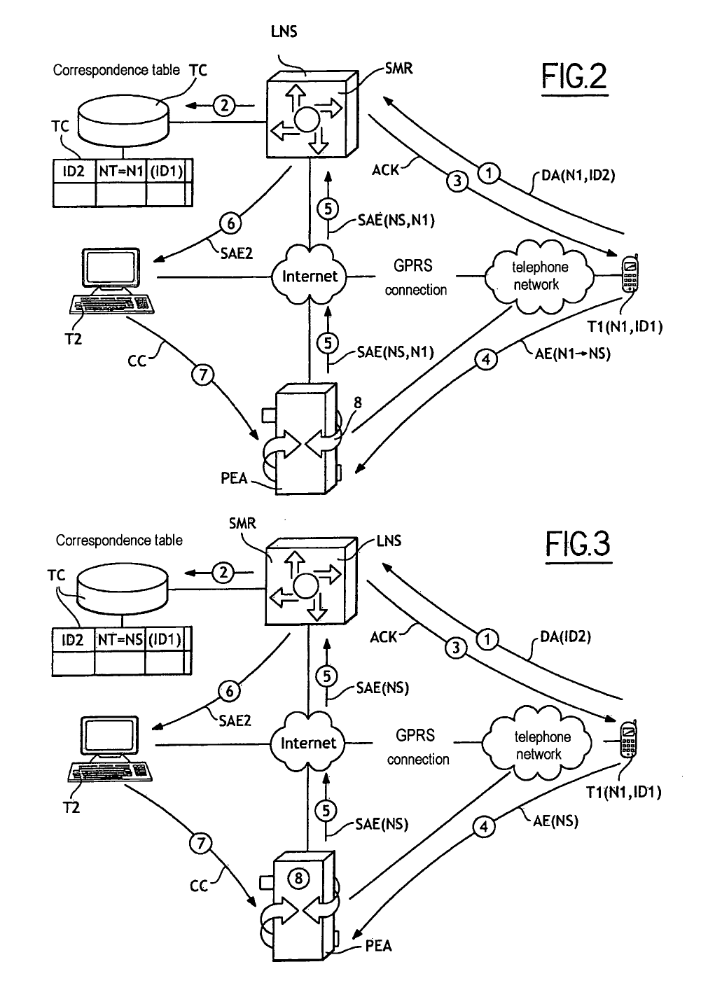

FIG. 2 is a diagram of a first embodiment of the FIG. 1 apparatus using calling party routing; and

FIG. 3 is a diagram of a second embodiment of the FIG. 1 device using called party routing.

In the figures, a first user is seeking to set up a call from a first terminal T1 (a telephone terminal) to a remote second terminal T2 of a second user that is connected to an IP network such as the Internet. Below, the first terminal T1 is typically a GPRS mobile telephone terminal, but it could equally well be a fixed telephone terminal communicating via a corresponding telephone network. The remote second terminal T2 is a fixed or mobile computer connected to an IP network, for example, and is referred to below as the IP terminal.

A connection infrastructure common to users of GPRS mobile terminals T1 and IP terminals provides predefined dynamic routing rules for ensuring that calls incoming to a gateway between the first and second terminals, such as a PSTN/IP gateway, are connected through to the called users.

This type of infrastructure is typically an IP-based presence management infrastructure, like those used for instant messaging.

The second terminal T2 is identified in the connection infrastructure by a predetermined second identifier ID2, which is typically not a telephone number and consists of an electronic mail address of the second terminal T2, for example, such as (in France) forename.name@domain.fr, where ‘name’ and ‘forename’ are those of the second user. The identifier ID2 makes identification of a second user by a first user less anonymous than a telephone number would.

In the figures, this connection infrastructure comprises one or more connection servers SMR and a correspondence table TC described below.

By means of this common connection infrastructure, the first and second users can coexist in the same identification space, the first terminal T1 can contact the connection server SMR and the connection server SMR can contact the second terminal T2. A call from the first terminal T1 to the server SMR uses the GPRS telephone network, a GPRS connection, and the Internet network, and vice versa in the opposite direction. A call between the server SMR and the second terminal T2 uses the Internet in both directions. For example, the second terminal T2 has notified its presence and made a connection to the connection server SMR beforehand, either at the initiative of the second user or automatically by a permanent connection when the second terminal T2 is switched on, for example by notifying its IP address and the port at which the second terminal T2 can be contacted. The connection to the service is effected by means of client applications in the second terminals T2 and onboard applications in the first terminals T1. These applications use IP connectivity to set up a connection with the server SMR. This type of architecture is typically based on elements compatible with the presence management protocols XMPP (eXtensible Messaging and Presence Protocol), SIMPLE (SIP for Instant Messaging and Presence Leveraging Extensions), and Wireless Village (registered trade mark). For example, the connection infrastructure enables the first and second users each to draw up a list of contacts or call destinations (“friends” list). The first terminal T1 is notified of the presence of the second terminal T2 on the IP network and the second terminal T2 is notified of the presence of the first terminal T1 on the mobile telephone network.

To initiate a call and to connect to the service provided by the invention and to the server SMR, during a step 1, the first user selects the second identifier ID2 on the first terminal T1 and commands the first terminal T1 to send a call request DA containing the second identifier ID2 to the connection server SMR using a communications protocol. For example, the first user keys in the second identifier ID2, because the user happens to know it, or an onboard application in the first terminal T1 prompts the first user to call the second user on the basis of the second identifier ID2 of the second terminal T2 in the connection infrastructure, for example by prompting the user to select from the list of contacts stored in the terminal T1, the terminal T2 that the server SMR has detected as being present.

Each time that the connection server SMR receives a call request DA, in a step 2, it associates a first telephone number NT with the called party identifier ID2 contained therein and temporarily stores that association in the correspondence table TC, where applicable with other characteristics of the future call. For each call request DA it receives, the server SMR determines the first telephone number NT temporarily and dynamically on the basis of the call request DA. This first telephone number NT is a service number and is therefore not assigned to the identifier ID2 in a static and definitive manner, but only during the call set-up stage, for example until a call is set up between the first and second terminals T1 and T2 in a step 8. Consequently, associations between identifiers ID2 and first numbers NT are stored dynamically in the correspondence table TC.

In the first embodiment, shown in FIG. 2, the call request DA contains the telephone number N1 of the first terminal that sent it (calling party) and the second identifier ID2 (called party). In this case, the first telephone number NT is the calling party telephone number N1 of the first terminal that sent the call request DA.

In the second embodiment, shown in FIG. 3, the call request DA does not contain the telephone number N1 of the sending first terminal (the calling party) but it does contain the second identifier ID2 (for the called party). In this case, the first telephone number NT is a service number NS determined by the server SMR for the call request DA containing the identifier ID2. For example, this service number NS is determined by the server SMR from a particular list (pool) LNS of service numbers reserved in the server SMR for pending call requests and is assigned to the call request DA containing the identifier ID2. These service numbers NS can therefore be assigned to any identifiers ID2 as and when call requests reach the server SMR.

Then, in a step 3, after the ID2—NT association has been stored in the table TC, the connection server SMR acknowledges the call request DA by sending the first terminal T1 that sent it a message or a corresponding ACK signal.

Reception of this acknowledgement by the first terminal T1 automatically causes it, during a step 4, to send an incoming call AE to the second number NS (a service number) communicated to the first terminal T1 in the acknowledgement, for example. By applying the routing rules established beforehand in the telephone network, this second number NS (a service number) connects through to the gateway PEA for setting up calls between the first and second terminals T1 and T2. The incoming call AE is transparent for the first user of the first terminal T1.

The incoming call reaches the gateway PEA via the telephone network with SS7 signaling. The incoming call AE contains a characteristic CAR informing the server SMR of a relationship between the first number NT and the second number NS (a service number). This characteristic CAR enables subsequent use of the first number NT to select one particular association (ID2, NT) from the associations in the correspondence table TC.

In the first embodiment, in which routing of the call is based on the calling party T1 and the calling party telephone number N1, the second number NS is a service number and is therefore different from the first number NT=N1. For example, this service number NS is determined by the server SMR from a particular list (pool) LNS of service numbers reserved in the server SMR for pending call requests. The characteristic CAR of the incoming call AE is therefore AE (N1→NS), for example, to specify a call to the (service) second number NS from the first terminal T1 having the telephone number N1.

The (service) second number NS or the service number list LNS has generally been reserved for the service provider beforehand by the telephone number assignment authority, and appropriate routing rules have generally been established in the fixed or mobile telephone network for routing these service numbers to the gateway PEA dedicated to the service.

In the second embodiment, in which call routing is based on the called party number NS in the incoming call AE, the (service) second number NS is therefore equal to the first number NT associated in the table TC with the identifier ID2. The characteristic CAR of the incoming call AE therefore consists for example solely of the mention AE(NS) of the (service) second number NS in the incoming call, which means that the relationship between the first number NT and the (service) second number NS is NT=NS and that the telephone number N1 of the first terminal T1 does not need to be sent in the incoming call AE.

When the gateway PEA has received the incoming call AE, it stores the (service) second number NS, in a step 5, as a pending incoming call to be subsequently connected to a destination IP terminal, and signals the received incoming call AE to the server SMR, for example via the Internet (signaling SAE). This signaling SAE sends the data contained in the incoming call AE, including the (service) second number NS and the characteristic CAR; thus in the first embodiment, the data that is sent comprises the telephone number N1 of the first terminal T1 and the (service) second number NS, while in the second embodiment, the data that is sent comprises only the (service) second number NS. In the first embodiment, the signaling SAE could also comprise only the telephone number N1 of the first terminal T1.

When the server SMR has received the signaling SAE of the incoming call AE, it extracts from that signaling the characteristic CAR of the incoming call AE and consults the records present in the table TC of correspondences to determine the associated called party identifier in the correspondence table TC as a function of CAR and TC. Thus the server SMR determines the second identifier ID2 (of the called party) associated in the correspondence table TC with the first number NT, which corresponds to the signaling SAE of the characteristic CAR of the incoming call AE.

In the first embodiment, the server SMR compares the signaled characteristic CAR=AE(N1→NS) or CAR(N1) with the records in the table TC, selects the record (ID2, N1) in the table TC on the basis of the signaled characteristic CAR=AE(N1→NS) or CAR(N1), and deduces the second identifier ID2 of the terminal T2 present in that record (ID2, N1) and associated with the number N1 present in the signaled characteristic CAR, the calling party number N1 being the discriminating factor enabling the server SMR to select the record (ID2, N1) in the table TC.

In the second embodiment, the server SMR compares the signaled characteristic CAR=AE(NS) with the records in the table TC, selects the record (ID2, NS) in the table TC on the basis of the signaled characteristic CAR=AE(NS), and deduces the second identifier ID2 of the terminal T2 present in that record (ID2, NS) and associated with the (service) second number NS present in the signaled characteristic CAR, the service number NS being the discriminating factor enabling selection of the record (ID2, NS) in the table TC.

When the second identifier ID2 (of the called party) has been determined in this way, the connection server SMR signals the incoming call AE (incoming call notification) to the second terminal T2 corresponding to this second identifier ID2 (called party) in a step 6. This signaling SAE2 of the incoming call AE is sent to the second terminal T2 via the Internet.

When it has received the signaling SAE2, the second terminal T2 sets up a multimedia communications channel CC with the gateway PEA via the Internet in a step 7, for example a voice and/or picture channel such as a voice over IP (VoIP) channel. This communications channel CC is set up on the basis of other characteristics supplied to the second terminal T2 in the signaling SAE2, for example derived from the incoming call AE in the step 4 and forwarded in the signaling SAE. These other characteristics relate to the assigned characteristics of the voice over IP channel, for example. Of course, the user of the terminal T2 (the second user) could refuse to allow the call to be set up, which would prevent execution of steps 7 and 8.

Finally, in the next step, step 8, the gateway PEA connects the communications channel CC set up with the second terminal T2 to the incoming call AE corresponding to the (service) second number NS, which incoming call it has kept pending. The call is therefore connected through end-to-end between the first terminal T1 and the second terminal T2. The first terminal T1 and the second terminal T2 can then communicate with each other and exchange sound and/or pictures via the gateway PEA providing IP/PSTN conversion between them. The method described can be used between other first terminals and other second terminals, of course.

In step 2, the server SMR may also store, in association with the second identifier ID2 (of the called party) or the called party service identifier ID2, the first identifier ID1 (of the calling party) or the calling party service identifier ID1, i.e. the identifier of the calling first terminal T1, present in the call request DA.

For example, the server SMR uses the calling party first identifier ID1 to verify that the first terminal T1 subscribes to the service and to execute other steps of the service if it finds that the first identifier ID1 present in the call request DA belongs to a file of users stored beforehand in the server SMR or to prevent execution of other steps of the service if it finds that the first identifier ID1 present in the call request DA does not belong to a file of users stored beforehand in the server SMR, for example by not sending the acknowledgement ACK to the first terminal T1 in step 3. The server SMR can decline to send the acknowledgement ACK to the first terminal T1 in step 3 for other reasons, for example because it detects in its database that the credit corresponding to the first identifier ID1 of the call request DA has been exceeded or has expired and/or because it detects that there are temporarily no longer any service numbers NS available for the incoming call AE because they have all been assigned to incoming calls AE at the time and/or because it detects that the first identifier ID1 of the call request DA is in a blacklist that it manages and that includes call barring.

For example, first identifier ID1 of the calling party is also sent in the incoming call AE signaled in step 6 for presentation to the second user on the second terminal T2.

After setting up the call in step 8, the server SMR can delete from the table TC the association (ID2, NT) between the second identifier N2 and the first number NT and, where applicable, other associated information.

1. A method of setting up multimedia calls from a (telephone) first terminal (T1) to a second terminal (T2) connected to an IP network wherein, in order to set up a call to the second terminal (T2) from the first terminal (T1), the method comprises:
the first terminal (T1) sends to a connection server (SMR) a call request (DA) containing a predetermined (called party) second identifier (ID2) for the second terminal (T2);
on receiving the call request (DA), the connection server (SMR) temporarily stores the (called party) second identifier (ID2) in a correspondence table (TC) in association with a first number (NT) determined from the call request (DA) and instigates the sending by the first terminal (T1) of an incoming call (AE) to a particular second number (NS) which is a service number connecting to a call set-up gateway (PEA), the incoming call (AE) including a call characteristic (CAR) to indicate a relationship between the first number (NT) and the (service) second number (NS); and
the call set-up gateway (PEA) signals at least the characteristic (CAR) of the received incoming call (AE) to the connection server (SMR), which determines the (called party) second identifier (ID2) associated in the correspondence table (TC) with the first number (NT) corresponding to the signaling (SAE) of the characteristic (CAR) of the incoming call (AE) in order to signal the incoming call to the second terminal (T2) corresponding to the (called party) second identifier (ID2) determined in this way, in order to set up a multimedia communications channel between the second terminal (T2) and the call set-up gateway (PEA), which then connects the multimedia communications channel to the incoming call.

2. A call set-up method according to claim 1, wherein the first number (NT) and the (service) second number (NS) are telephone numbers.

3. A call set-up method according to claim 1, wherein the (telephone) first terminal (T1) is a GPRS mobile telephone terminal.

4. A call set-up method according to claim 1, wherein the second terminal (T2) is connected beforehand to the connection server (SMR) using a presence management protocol.

5. A call set-up method according to claim 4, wherein the (called party) second identifier (ID2) is selected on the first terminal (T1), selection of the (called party) second identifier (ID2) on the first terminal (T1) being possible because the presence of the second terminal (T2) has been detected and signaled to the first terminal (T1) by the connection server (SMR).

6. A call set-up method according to claim 1, wherein the first number (NT) associated in the correspondence table (TC) with the second identifier (ID2) is the telephone number (N1) of the first terminal (T1) contained in the call request (DA) and the characteristic (CAR) of the incoming call (AE) for indicating a relationship between the first number (NT) and the (service) second number (NS) designates the incoming call (AE(N1→N)) coming from the telephone number (N1) of the first terminal (T1) and going to the (service) second number (NS).

7. A call set-up method according to claim 1, wherein the first number (NT) associated in the correspondence table (TC) with the second identifier (ID2) is the telephone number (N1) of the first terminal (T1) contained in the call request (DA) and the characteristic (CAR) of the incoming call (AE) for indicating a relationship between the first number (NT) and the (service) second number (NS) designates the incoming call (AE(N1→N)) coming from the telephone number (N1) of the first terminal (T1) and going to the (service) second number (NS).

8. A call set-up method according to claim 1, wherein the first number (NT) associated in the correspondence table (TC) with the second identifier (ID2) is the (service) second number (NS) and the characteristic (CAR) of the incoming call (AE) for indicating a relationship between the first number (NT) and the (service) second number (NS) designates the (service) second number (NS).

9. A call set-up method according to claim 8, wherein the telephone number (N1) of the first terminal (T1) is contained neither in the call request (DA) nor in the incoming call (AE).

10. A call set-up method according to claim 1, wherein the connection server (SMR) determines the (service) second number (NS) from a pre-stored list (LNS) of service numbers available for the call request (DA) and is communicated to the first terminal (T1) in an acknowledgement (ACK) sent by the connection server (SMR) after the (called party) second identifier (ID2) is stored in the correspondence table (TC).

11. A call set-up method according to claim 1, wherein the incoming call (AE) contains other characteristics of the communications channel (CC) to be set up which are also signaled with the incoming call (AE) to the connection server (SMR) and to the second terminal (T2).

12. A call set-up method according to claim 1, wherein a first identifier (ID1) of the first terminal (T1) is present in the call request (DA) and is stored by the connection server (SMR) in association with the (called party) second identifier (ID2) and the first number (NT).

13. A call set-up method according to claim 1, wherein the identifier (ID1, ID2) is different from a telephone number of the corresponding terminal (T1, T2).

14. Apparatus for implementing the method according to claim 1, for setting up multimedia calls from a (telephone) first terminal (T1) to a second terminal (T2) connected to an IP network, wherein the apparatus comprises:
a gateway (PEA) for setting up calls between the first and second terminals (T1, T2);
a connection server (SMR) including means for receiving a call request (DA) from the first terminal (T1) and means for commanding the first terminal (T1) to send an incoming call (AE) to a particular second number (NS) which is a service number connecting through to the call set-up gateway (PEA), the incoming call (AE) including a call characteristic (CAR) for indicating a relationship between a first number (NT) and the (service) second number (NS);
a correspondence table (TC) for storing the (called party) second identifier (ID2) for the second terminal (T2) contained in the call request (DA) in association with the first number (NT) determined from the call request (DA);
first means in the call set-up gateway (PEA) for signaling at least the characteristic (CAR) of the incoming call (AE) to the connection server (SMR);
means in the connection server (SMR) for determining the (called party) second identifier (ID2) associated in the correspondence table (TC) with the first number (NT) corresponding to the signaling (SAE) of the characteristic (CAR) of the incoming call (AE) and second means for signaling the incoming call to the second terminal (T2) corresponding to the (called party) second identifier (ID2) determined in this way;
means for instigating the setting up of a multimedia communications channel between the second terminal (T2) and the call set-up gateway (PEA); and
means for connecting the multimedia communications channel to the incoming call via the call set-up gateway (PEA).

15. A connection server for implementing the method of claim 1, comprising:
receiver means adapted to receive from a first terminal (T1) a call request (DA) containing a predetermined (called party) second identifier (ID2) for the second terminal (T2);
storage means adapted to store the (called party) second identifier (ID2) in a correspondence table (TC) in association with a first number (NT) determined from the call request (DA);
receiver means adapted to receive from a call set-up gateway (PEA) at least the characteristic (CAR) of an incoming call (AE) received by said gateway, the incoming call (AE) including a call characteristic (CAR) for indicating a relationship between the first number (NT) and the (service) second number (NS); and
determination means adapted to determine the (called party) second identifier (ID2) associated in the correspondence table (TC) with the first number (NT) corresponding to the signaling (SAE) of the characteristic (CAR) of the incoming call (AE), in order to signal the incoming call to the second terminal (T2) corresponding to the (called party) second identifier (ID2) determined in this way.

16. A call set-up gateway (PEA) for implementing the method of claim 1, comprising:
receiver means adapted to receive from a terminal (T1) an incoming call (AE) to a particular (service) second number (NS), the incoming call (AE) including a call characteristic (CAR) for indicating a relationship between a first number (NT) and a (service) second number (NS);
signaling means adapted to signal at least the characteristic (CAR) of the received incoming call (AE) to a connection server (SMR) that determines the (called party) second identifier (ID2) associated in a correspondence table (TC) with the first number (NT) corresponding to the signaling (SAE) of the characteristic (CAR) of the incoming call (AE).

17. A second terminal (T2) for implementing the method of claim 1, comprising:
receiver means adapted to receive signaling of an incoming call coming from a first terminal (T1); and
means adapted to set up a multimedia communications channel with a call set-up gateway (PEA) which then connects the multimedia communications channel to the incoming call.
